(19) United States
(12) Patent Application Publication
(10) Pub. No.: US 2023/0179814 A1
(43) Pub. Date: Jun. 8, 2023

(54) MULTIPLE SOURCE, MULTIPLE FORMAT MEDIA SELECTION AND CONTROL

(71) Applicant: AT&T Intellectual Property I, L.P., Atlanta, GA (US)

(72) Inventors: Brian M. Novack, St. Louis, MO (US); Rashmi Palamadai, Naperville, IL (US); Tan Xu, Bridgewater, NJ (US); Eric Zavesky, Austin, TX (US); Ari Craine, Marietta, GA (US); Richard Palazzo, Stewartsville, NJ (US); Robert Koch, Peachtree Corners, GA (US)

(21) Appl. No.: 17/541,049

(22) Filed: Dec. 2, 2021

(51) Int. Cl. H04N 21/2665; H04N 21/2187; H04N 21/235

(52) U.S. Cl. CPC H04N 21/2665; H04N 21/2187; H04N 21/2353

(57) ABSTRACT

The technology described herein is generally directed towards allowing a user to switch among media streams of live events, including generally concurrent events, and among different media streams that are available for the same event. The media streams can be virtual reality streams, video streams and audio streams, and can be from different viewing and/or listening perspectives and quality. The user can see (and hear) previews of a stream, and see metadata associated with each available stream, such as viewer rating, cost to use, video quality data, and a count of current viewers. Via a social media service, a user can sees whether any friends are also viewing. An event that is not streamed in virtual reality can be viewed via a virtual reality device by presenting the event via a virtual element, such as a virtual television set, within the virtual environment.

### TECHNICAL FIELD

The subject application relates to the presentation of media content in general, and more particularly to selection of available media content streams of live events.

### BACKGROUND

With live streaming becoming prevalent, there are many events that a participant would like to attend remotely. Sometimes these events occur at generally the same time, and at present there is no convenient way to attend both, even remotely.

Moreover, the same event can have different streaming experiences provided by different media creators, including in different formats. For example, a concert may be streamed in virtual reality and in 8K video, 4K video and so on. There may be streams from different source locations, e.g., one as an official stream, one from the audience perspective. Audio can similarly be captured and streamed from different sources.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram showing example components that facilitate multiple source, multiple format media selection and control for media streamed events, in accordance with various aspects and embodiments of the subject disclosure.

FIG. 2 is an example representation of different sources that provide different media streams of live events, in accordance with various aspects and embodiments of the subject disclosure.

FIG. 3 is a representation of an example user interface by which a user can evaluate, select and switch between different media streams for live events, in accordance with various aspects and embodiments of the subject disclosure.

FIG. 4 is a representation of users in a virtual environment viewing a non-virtual reality streamed event via a virtual display device in the virtual environment, in accordance with various aspects and embodiments of the subject disclosure.

FIG. 5 is a representation of virtual reality streamed event in which a user can change between audio streams, in accordance with various aspects and embodiments of the subject disclosure

FIG. 6 is a representation of virtual reality streamed event in which a user can change to a different streamed event, in accordance with various aspects and embodiments of the subject disclosure

FIG. 7 is a flow diagram representing example operations related to offering first and second media streams for user selection, in accordance with various aspects and embodiments of the subject disclosure.

FIG. 8 is a flow diagram representing example operations related to presenting first and second media streams as a user selects and switches among them, in accordance with various aspects and embodiments of the subject disclosure.

FIG. 9 is a flow diagram representing example operations related to presenting media streams as a user selects among them, in accordance with various aspects and embodiments of the subject disclosure.

FIG. 10 illustrates an example block diagram of an example mobile handset operable to engage in a system architecture that facilitates wireless communications according to one or more embodiments described herein.

FIG. 11 illustrates an example block diagram of an example computer/machine system operable to engage in a system architecture that facilitates wireless communications according to one or more embodiments described herein.

### DETAILED DESCRIPTION

The technology described herein is generally directed towards allowing a user to preview, select, and control his or her consumption of media, such as video or virtual reality content. The content, e.g., transmitted as media stream, may be created and made available by multiple source users, including at different perspectives for the same event.

To select among available streams, in one implementation the user may define a genre for an experience and be presented with available media streams for that genre. Once a media stream is selected, (which can be an event media stream group, e.g., one for video, one for audio), the user may switch among the available streams. Further, when available as an option, the user may control aspects of the source users, such to move a source user to a different location, change the source user's camera orientation, and so forth.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

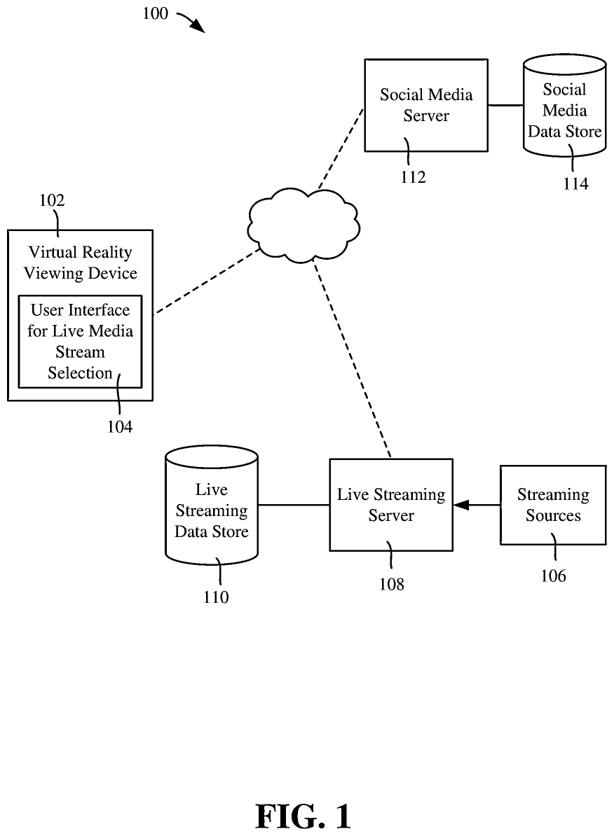

FIG. 1 is a block diagram of example components of a system 100 that allows a user to select among and experience streamed content, while also providing a way for streaming sources 106 including media source creators to contribute their captured content to a platform that makes the content available to event consumers (e.g., user viewers/listeners) in what can be a very immersive manner In the non-limiting examples presented herein, the user is a person equipped with a virtual reality viewing device (e.g., headset and earphones) that provides a user interface 104 for live media stream selection, and once selected, presents the selected stream in a virtual reality view. Notwithstanding, it is understood that any device capable of presenting streamed content (e.g., a smartphone, a television set and so on) may be used by an event consumer.

As will be understood, the user interface 104 provides a way for a user that wants to experience parts of a number of different events (concerts in the examples) that are in progress live at a given time. While the examples describe a user hopping virtually from concert to concert, it may be used in other applications as well, such as sporting events, theatrical events, museum tours, or others. A user may search for events, such as via a genre (e.g., rock concerts) but also may select from known events. Multiple events can be of different genres (e.g., a football game of interest and a concert). Further, the user can select among different source streams of the same event, when multiple source streams are available for the same event.

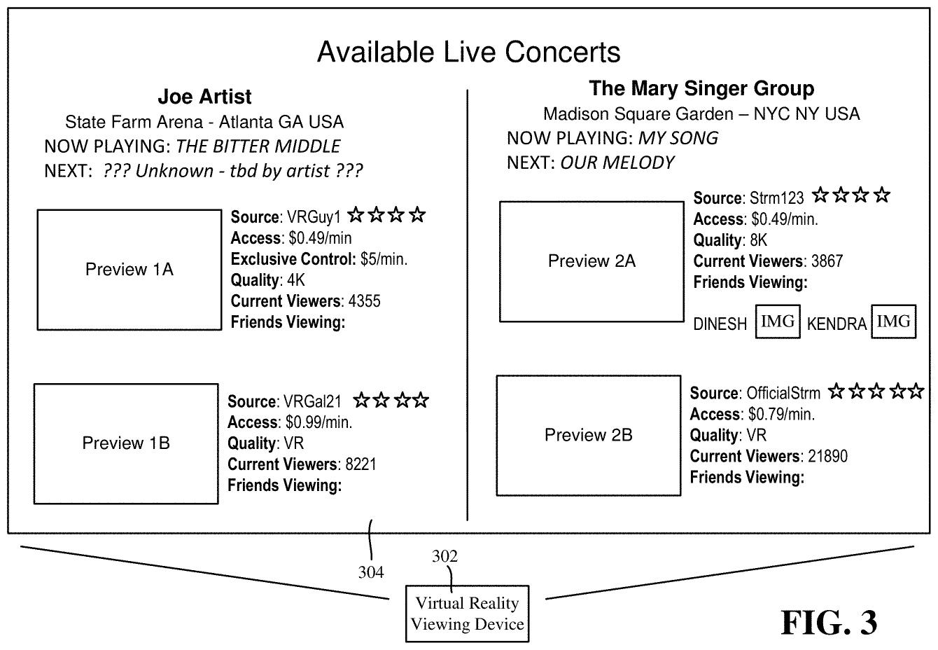

In FIG. 1, a live streaming service represented as a live streaming server 108 and live streaming data store 110 obtains the streamed content from the streaming sources 106. The live streaming server 108 sends previews (e.g., actual live feeds from the event, previous captured sample feeds and/or images) and metadata to the potential event consumers, including the example user with the virtual reality viewing device 102. The previews and metadata are used to present the live stream offerings via the user interface 104 as described herein with reference to FIG. 3. A social media service represented as a social media server 112 and social media data store 114 can be accessed for information, as also described herein with reference to FIG. 3.

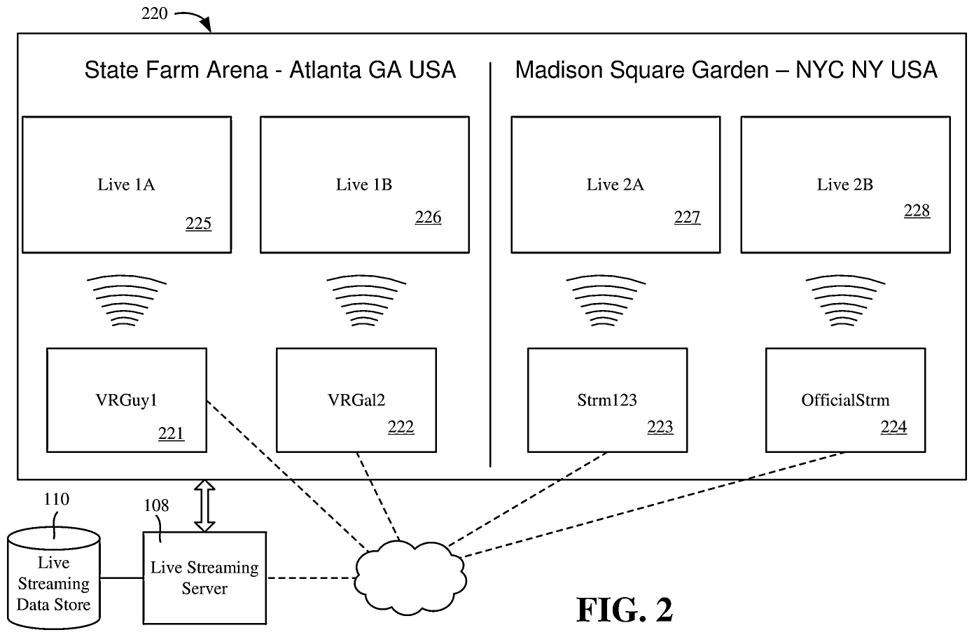

With respect to creating the source media, as shown in FIG. 2 a platform 220 such as implemented on the live streaming server 108 can be accessed by one or more source media creators that may exist at each event location. The source media creators, represented via blocks 221-224 in FIG. 2, may use wearable cameras or other types of cameras to capture video content at the events; in the example of FIG. 2 this provides different options 225 and 226 for one event, and options 227 and 228 for another event. The wearable cameras may be standard video cameras that are varying levels of quality, or may be 360 degree video cameras. The source media creators 221-224 also may be equipped with microphones to capture audio at their respective locations. In addition to the mobile wearable/other cameras, there may be fixed cameras and microphones that are stationed at the events that are also capable of capturing video and audio. For example, there can be one or more official video and/or audio streams provided by the event producer or the like.

Each video stream and audio stream may be captured and made available to the live streaming server 108. Streams that are for the same event may be stored as such in the live streaming data store 110 so that they may be identified as belonging to that event when presented as an option to a viewer later. As set forth above, an official audio stream and official video stream (e.g., block 224) may be presented and made available to the live streaming server 108. The official audio stream may be produced by one of the source media creators. Alternatively, the official audio stream may be presented by another source at the event such that the official audio stream is a clean presentation of audio from microphones on stage or at the sound mixing booth, e.g., as heard through the headphones by the live sound engineers. In sum, the live streaming server 108 has access to the available audio and video streams at each event and may make them available to viewers as requested.

The live streaming server 108 presents the available streams and sources, such as shown in the example user interface representation 304 in FIG. 3. If the event is live, the preview can show the event video from the creator's perspective, or sample images of the event video so that the user will pay for the full experience. If not yet live, the preview can stream replayed content, interviews, a list of expected songs (if a concert) and/or event (e.g., stage) preparations or the like to entice the user to select the corresponding stream.

In this example, each of the available streams also display accompanying information based on their related metadata. For instance, a source identifier (ID) for the media may be sent as metadata along with the stream. Example metadata that can be sent for display includes the video resolution/quality/type (e.g., 8K, 4K, VR) may also be sent as metadata for display. If the source media is 360 degree video, it may be converted to virtual reality (VR) by the live streaming server 108 and the format available for it may be presented as being VR. The live streaming server may also retrieve a source rating from a database for each source based on the source ID and display the rating in some way, for instance as a star rating as in the example of FIG. 3. The menu of available streams may also present the number of current viewers that the live streaming server is currently serving.

The source media creators may be persons authorized to stream video by each event's organizers or the like, and may have preregistered with the live streaming server 108 to set respective prices for access to their respective streams. A source media creator may present an option to a viewer to give them exclusive control to the stream that they are creating; an example is shown in the metadata represented to the right of “Preview 1A” in FIG. 2. This exclusive control option may be saved as a profile option in the source media creator's preregistration record, for example Exclusive control may permit one viewer (at a time) to provide instructions to the source media creator, for example, via spoken, text or other commands as to which direction the source media creator should look or where the source media creator should move. A camera at a fixed location can be remotely controlled to change its viewing angle, for example, in a similar way.

The user device (e.g., VR headset) may be equipped with an application such as a social media application program. This can be used to access to the viewer's social media contacts. The social media application may provide to the live streaming server 108 a list of contacts that may be checked in the social media server 112 (FIG. 1) to determine if any of the viewer's contacts are also viewing any of the available streams. If any of the viewer's friends are doing so, they may be shown as such on the menu of options. For example, in the display of metadata to the right of preview 2A, two friends are identified via their names (Dinesh and Kendra) and associated images.

The live streaming server 108 also may have access to data that describes the current state of the event and also upcoming states of the event. For instance, for concerts as in the example of FIG. 3, the current state (shown above the previews of each concert) may be the artist and song that is now playing; an upcoming state may be the next song, if known. This data may be supplied to, for instance, an administrative interface on the live streaming server 108 in real time or may otherwise be determined based on a timed schedule or other means, such as analysis of the streaming audio or video to detect the beginning or end of a song, as well as to identify the song if needed.

Via interaction with the user interface 304, the viewer may select one of the available sources as a video source. The selection may be accomplished using standard (e.g., VR) controls and selection mechanisms.

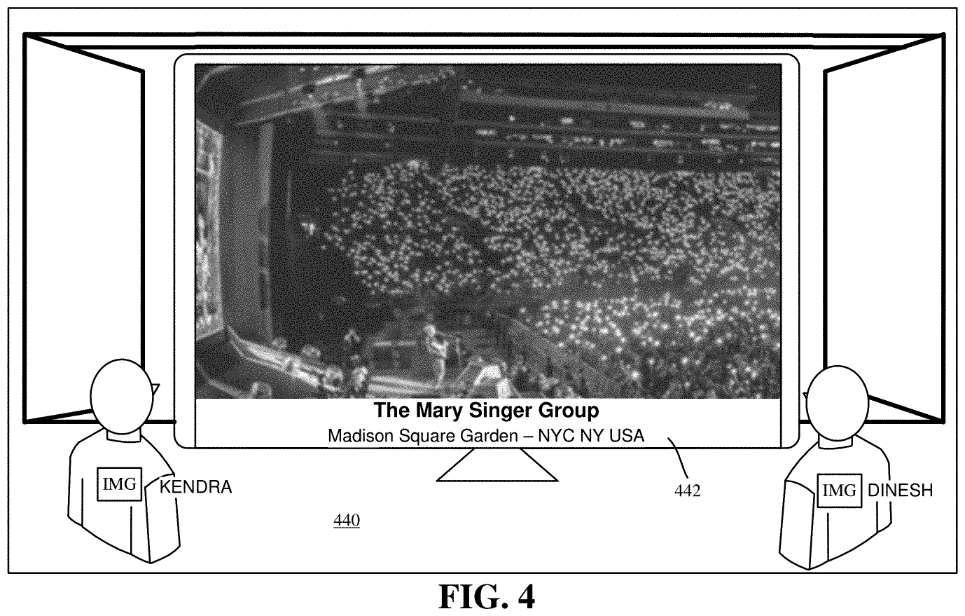

If the source media selected is in a non-virtual reality format, the source media may be presented within a virtual reality environment as an element within the environment. For example, in the virtual reality environment 440 of FIG. 4, the source media is presented as an element 442 in the form of a television or projector screen. This may be done using an application program on the virtual reality headset. If a social or other connection is also viewing the same event, they may be presented as virtual participants within the virtual reality environment 440 environment, (e.g., Dinesh and Kendra), such as displayed as avatars with their respective images.

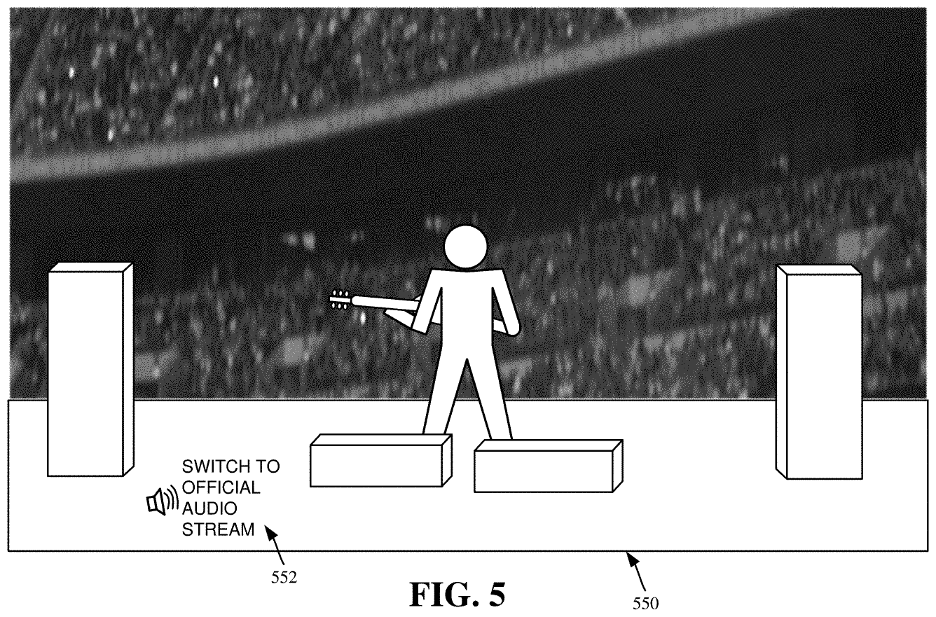

As represented in the example of FIG. 5, if the source media selected is in a format that can be converted to virtual reality, for instance, a 360 degree video, then the virtual reality viewer is presented with the virtual reality experience (block 550) of the video via a virtual reality stream. The audio presented may be the audio that is captured from the original source media creator. Alternatively, the viewer may select an alternate audio stream which may enhance the experience for the viewer.

If the viewer uses their standard virtual reality selection commands to select the alternate audio stream (the selection option is represented in FIG. 5 by the overlay 552), a command is sent from the virtual reality headset/headphones to the live stream server to switch the audio stream while maintaining the video stream. In this case, the viewer is presented with video from one source and audio from a different source.

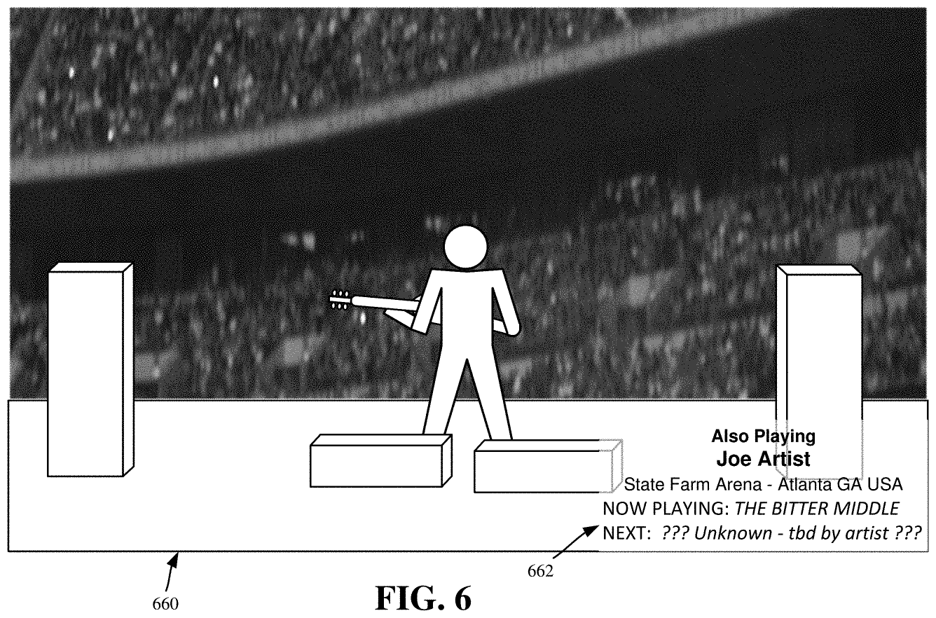

As represented in the example of FIG. 6, while viewing one event (represented via view 660), the viewer may monitor other events of interest. The status of the other events may be presented via an overlay (e.g., overlay 662) on the viewer's current view 660. The viewer may interact to select the overlay to switch streams from the currently viewed stream to the other stream. The viewer also may interact to return to the user interface 304 of FIG. 3 to switch events and/or switch between streams of the same event.

It is also feasible for a user to interact with the live streaming server 108 to pause an event and resume it later from the paused point. For example, if the user's favorite songs are being played at different concerts at generally the same time, rather than miss one song, the user can pause one event, switch to the other, and switch back to the paused event, resuming from the paused point. The live streaming server can maintain the streamed event data and the pause location data for the user ID in the live streaming data store 110. Rewind and fast forward functions and the like (e.g., slow motion such as for a sporting event) can be made available in a similar way. Such functions may, for example, be offered for an additional fee.

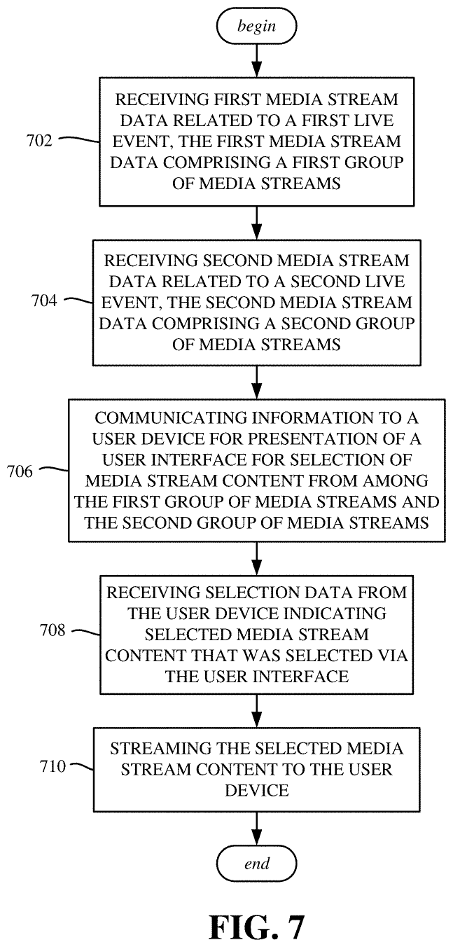

One or more example aspects are represented in FIG. 7, and can correspond to a system, including a processor, and a memory that stores executable instructions that, when executed by the processor, facilitate performance of operations. Example operation 702 represents receiving first media stream data related to a first live event, the first media stream data comprising a first group of media streams. Operation 704 represents receiving second media stream data related to a second live event, the second media stream data comprising a second group of media streams. Operation 706 represents communicating information to a user device for presentation of a user interface for selection of media stream content from among the first group of media streams and the second group of media streams. Operation 708 represents receiving selection data from the user device indicating selected media stream content that was selected via the user interface. Operation 710 represents streaming the selected media stream content to the user device.

The user device can include a virtual reality viewer.

Further operations can include obtaining media content in a non-virtual reality format, and communicating the media content for presentation as an element within a virtual reality environment corresponding to the virtual reality viewer.

The selected media stream content can include a selected audio stream and a selected video stream from different sources.

The first group of media streams can include an audio stream and respective video streams from respective different sources.

Streaming the selected media stream content can include streaming a first audio stream and a first video stream, and further operations can include receiving updated selection data indicating a selection switch to a second audio stream, and, in response to the receiving the updated selection data, switching from streaming the first audio stream to streaming the second audio stream while streaming the first video stream.

Streaming the selected media stream content can include streaming a first audio stream and a first video stream, and further operations can include receiving updated selection data indicating a selection switch to a second video stream, and, in response to the receiving the updated selection data, switching from streaming the first video stream to streaming the second video stream while streaming the first audio stream.

Streaming the selected media stream content can include streaming a first audio stream and a first video stream, and further operations can include receiving updated selection data indicating a selection switch to a second audio stream and a second video stream, and, in response to the receiving the updated selection data, switching from streaming the first audio stream and first video stream to streaming the second audio stream and the second video stream.

Streaming the selected media stream content can include streaming a first audio stream and a first video stream, and further operations can include receiving a pause request, receiving first updated selection data indicating a first selection switch to a second audio stream and a second video stream, in response to the receiving the pause request, maintaining information representing playback location data for the first audio stream and the first video stream, in response to the receiving the first updated selection data, switching from streaming the first audio stream and first video stream to streaming the second audio stream and the second video stream, receiving second updated selection data indicating a second selection switch to the first audio stream and the first video stream, and, in response to the receiving the second updated selection data, switching from streaming the second audio stream and the second video stream to streaming the first audio stream and the first video stream based on the playback location data.

Streaming the selected media stream content can include streaming a first video stream for primary output on the user device, and streaming a second video stream for secondary output on the user device.

Receiving the first media stream data can include receiving first metadata associated with the first live event and second metadata associated with the second live event, and wherein the communicating the information to the user device for presenting the user interface comprises sending first preview content and first information based on the first metadata, and sending second preview content and second information based on the second metadata for presenting as part of the user interface.

Further operations can include obtaining contact data from a social media source, the contact data related to contacts of a user associated with the user device, determining whether the contact data indicates one or more contacts of the user are viewing the first live event or the second live event, and, in response to the contact data indicating that the one or more contacts of the user are viewing the first live event or the second live event, communicating contact information to the user device for presenting as part of the user interface.

Further operations can include obtaining contact data from a social media source that indicates a contact of the user is viewing the first live event and presenting a representation of the contact data as virtual participant.

Further operations can include obtaining state data comprising at least one of: first state data that describes a current state of the first live event, or second state data that describes an upcoming state of the first live event, and communicating information corresponding to the state data to the user device for presentation as part of the user interface.

Further operations can include receiving control command data directed to a source media entity, and forwarding the control command data to the source media entity.

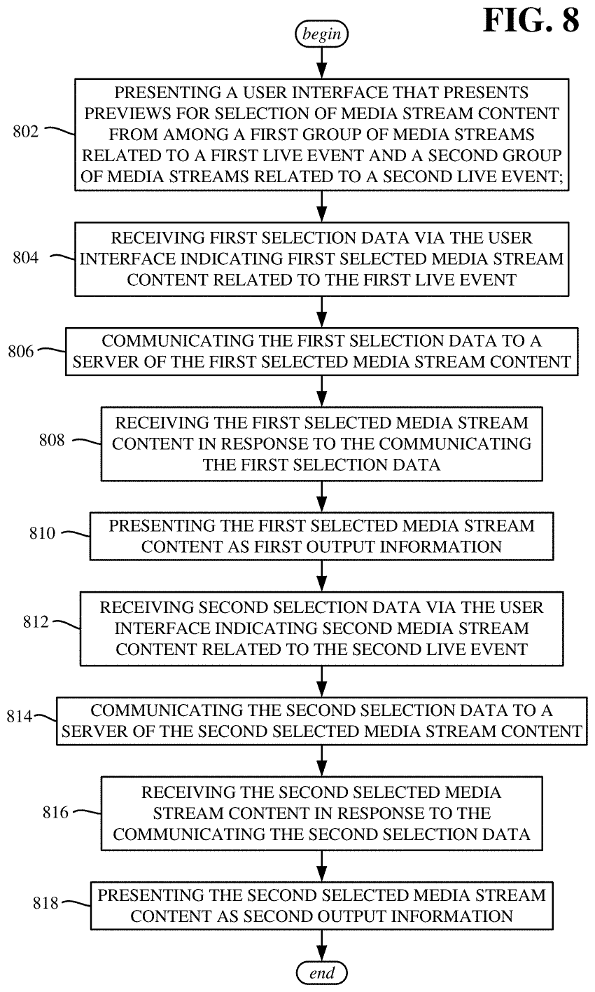

One or more example aspects are represented in FIG. 8, and, for example, can correspond to operations, such as of a method. Example operation 802 represents presenting, by a user device comprising a processor a user interface that presents previews for selection of media stream content from among a first group of media streams related to a first live event and a second group of media streams related to a second live event. Operation 804 represents receiving, by the user device, first selection data via the user interface indicating first selected media stream content related to the first live event. Operation 806 represents communicating, by the user device, the first selection data to a server of the first selected media stream content. Operation 808 represents receiving, by the user device, the first selected media stream content in response to the communicating the first selection data. Operation 810 represents presenting, by the user device, the first selected media stream content as first output information. Operation 812 represents receiving, by the user device, second selection data via the user interface indicating second media stream content related to the second live event. Operation 814 represents communicating, by the user device, the second selection data to a server of the second selected media stream content. Operation 816 represents receiving, by the user device, the second selected media stream content in response to the communicating the second selection data. Operation 818 represents presenting, by the user device, the second selected media stream content as second output information.

Part of the first selected media stream content can correspond to a first source related to the first live event; further operations can include receiving, by the user device, third selection data via the user interface indicating third media stream content from a second source related to the first live event, communicating, by the user device, the third selection data to a server of the third selected media stream content, receiving, by the user device, the third selected media stream content in response to the communicating the third selection data, and presenting, by the user device, the third selected media stream content as third output information.

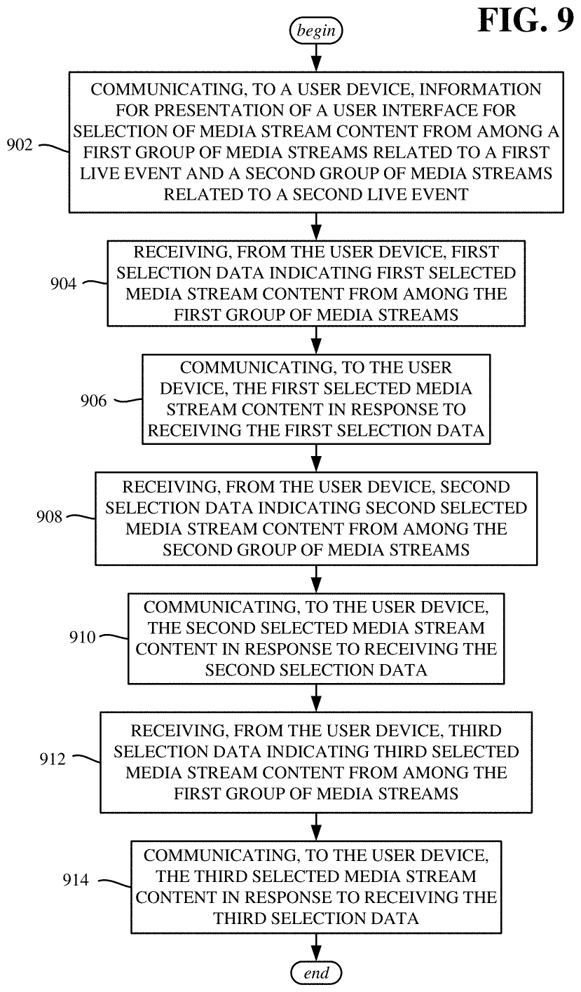

One or more aspects are represented in FIG. 9, such as implemented in a machine-readable medium, including executable instructions that, when executed by a processor, facilitate performance of operations. Example operation 902 represents communicating, to a user device, information for presentation of a user interface for selection of media stream content from among a first group of media streams related to a first live event and a second group of media streams related to a second live event. Operation 904 represents receiving, from the user device, first selection data indicating first selected media stream content from among the first group of media streams. Operation 906 represents communicating, to the user device, the first selected media stream content in response to receiving the first selection data. Operation 908 represents receiving, from the user device, second selection data indicating second selected media stream content from among the second group of media streams. Operation 910 represents communicating, to the user device, the second selected media stream content in response to receiving the second selection data. Operation 912 represents receiving, from the user device, third selection data indicating third selected media stream content from among the first group of media streams. Operation 914 represents communicating, to the user device, the third selected media stream content in response to receiving the third selection data.

Communicating the first selected media stream content to the user device in response to receiving the first selection data can include streaming an audio stream and a first video stream from among the first group of media streams, and communicating the third selected media stream content to the user device in response to receiving the third selection data can include streaming the audio stream and a second video stream from among the first group of media streams.

Communicating the information to the user device for presentation of the user interface can include sending at least one of: metadata related to the first live event, or contact data related to a viewer of the first live event.

As can be seen, the technology described herein facilitates selection by a user (an event viewer) of media streams, including among multiple available media steams for live events. The technology allows multiple media source creators to contribute their content to a platform that makes their captured content available to an event viewer in an immersive manner.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

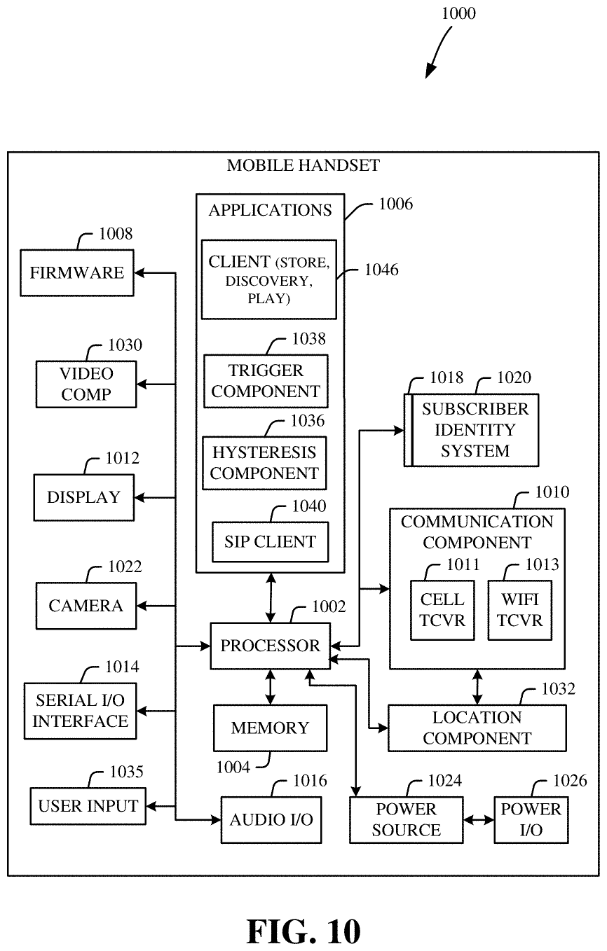

Referring now to FIG. 10, illustrated is a schematic block diagram of an example end-user device (such as user equipment) that can be a mobile device 1000 capable of connecting to a network in accordance with some embodiments described herein. Although a mobile handset 1000 is illustrated herein, it will be understood that other devices can be a mobile device, and that the mobile handset 1000 is merely illustrated to provide context for the embodiments of the various embodiments described herein. The following discussion is intended to provide a brief, general description of an example of a suitable environment 1000 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1094) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1022 (e.g., a camera) can be provided for decoding encoded multimedia content. The video processing component 1022 can aid in facilitating the generation, editing and sharing of video quotes. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 810, includes an indoor network radio transceiver 1013 (e.g., Wi-Fi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

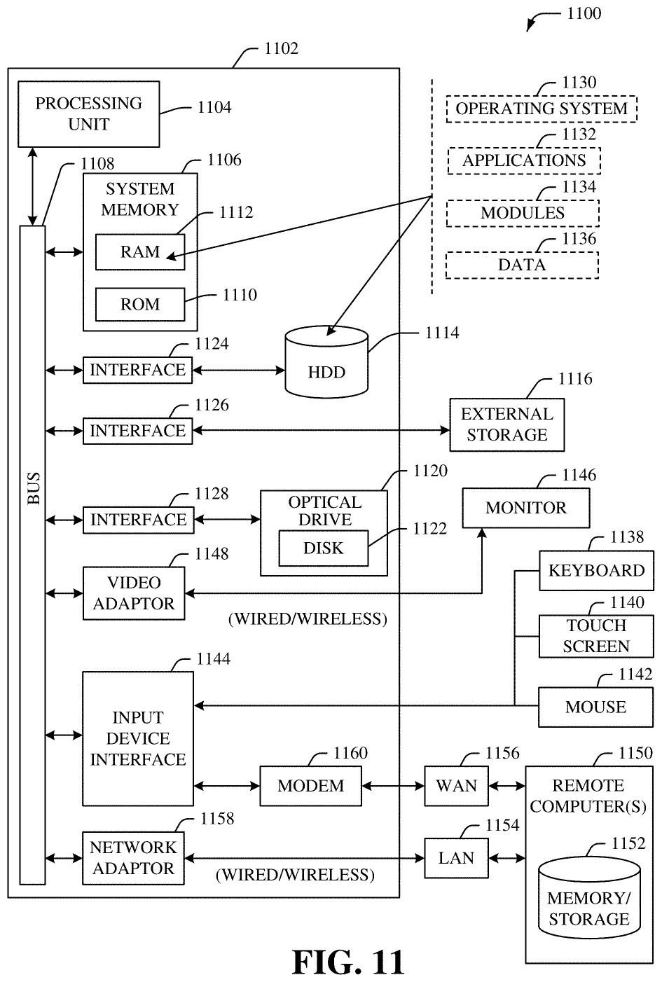

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD), non-volatile memory and other storage technology could be used in addition to, or in place of, an HDD 1114, and can be internal or external. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1094 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 11 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

1. A system, comprising:
a processor; and
a memory that stores executable instructions that, when executed by the processor of the system, facilitate performance of operations, the operations comprising:
receiving first media stream data related to a first live event, the first media stream data comprising a first group of media streams that are identified by the system as being related to the first live event;
receiving second media stream data related to a second live event, the second media stream data comprising a second group of media streams that are identified by the system as being related to the second live event;
communicating information to a user device for presentation of a user interface for selection of media stream content from among the first group of media streams and the second group of media streams;
receiving selection data from the user device indicating selected media stream content that was selected via the user interface; and
streaming the selected media stream content to the user device.

2. (canceled)

3. The system of claim 2, wherein the user device comprises a virtual reality viewer, and wherein the operations further comprise obtaining media content in a non-virtual reality format, and communicating the media content for presentation as an element within a virtual reality environment corresponding to the virtual reality viewer.

4. (canceled)

5. The system of claim 1, wherein the first group of media streams comprises an audio only stream from an audio source that captures audio related to the first live event and respective video streams from respective different video sources that respectively capture different visual information related to the first live event.

6. The system of claim 1, wherein the selected media content comprises at least one of the first group of media streams related to the first live event, wherein streaming the selected media stream content comprises streaming a first audio stream related to the first live event and a first video stream related to the first live event, and wherein the operations further comprise receiving updated selection data indicating a selection switch to a second audio stream related to the first live event, and, in response to the receiving the updated selection data, switching from streaming the first audio stream to streaming the second audio stream while continuing to stream the first video stream.

7. The system of claim 1, wherein the selected media content comprises at least one of the first group of media streams related to the first live event, wherein streaming the selected media stream content comprises streaming a first audio stream related to the first live event and a first video stream related to the first live event, and wherein the operations further comprise receiving updated selection data indicating a selection switch to a second video stream related to the first live event, and, in response to the receiving the updated selection data, switching from streaming the first video stream to streaming the second video stream while continuing to stream the first audio stream.

8. The system of claim 1, wherein the selected media content comprises at least one of the first group of media streams related to the first live event, wherein streaming the selected media stream content comprises streaming a first audio stream related to the first live event and a first video stream related to the first live event, and wherein the operations further comprise receiving updated selection data indicating a selection switch to a second audio stream related to the first live event and a second video stream related to the first live event, and, in response to the receiving the updated selection data, switching from streaming the first audio stream and first video stream to streaming the second audio stream and the second video stream and discontinuing the streaming of the first audio stream and the first video stream.

9. The system of claim 1, wherein the selected media content comprises at least one of the first group of media streams related to the first live event, wherein streaming the selected media stream content comprises streaming a first audio stream related to the first live event and a first video stream related to the first live event, and wherein the operations further comprise receiving a pause request, receiving first updated selection data indicating a first selection switch to a second audio stream related to the second live event and a second video stream related to the second live event, in response to the receiving the pause request, maintaining information representing playback location data for the first audio stream and the first video stream, in response to the receiving the first updated selection data, switching from streaming the first audio stream and the first video stream to streaming the second audio stream and the second video stream, receiving second updated selection data indicating a second selection switch to the first audio stream and the first video stream, and, in response to the receiving the second updated selection data, switching from streaming the second audio stream and the second video stream to streaming the first audio stream and the first video stream based on the playback location data to resume the streaming of the first audio stream and the first video stream from respective playback locations when the pause request was received.

10. (canceled)

11. The system of claim 1, wherein streaming the selected media stream content comprises streaming a first video stream for primary output on the user device, and streaming a second video stream for secondary output on the user device, wherein receiving the first media stream data comprises receiving first metadata associated with the first live event and second metadata associated with the second live event, and wherein the communicating the information to the user device for presenting the user interface comprises sending first preview content and first information based on the first metadata, and sending second preview content and second information based on the second metadata for presenting as part of the user interface.

12. The system of claim 1, wherein the operations further comprise obtaining contact data from a social media source, the contact data related to contacts of a user associated with the user device, determining whether the contact data indicates one or more contacts of the user are viewing the first live event or the second live event, and, in response to the contact data indicating that the one or more contacts of the user are viewing the first live event or the second live event, communicating contact information to the user device for presenting as part of the user interface.

13. The system of claim 1, wherein the operations further comprise obtaining contact data from a social media source that indicates a contact of the user is viewing the first live event and presenting an avatar representation of the contact data as virtual participant.

14. The system of claim 1, wherein the operations further comprise obtaining state data comprising at least one of: first state data that describes a current state of the first live event, or second state data that describes an upcoming state of the first live event, and communicating information corresponding to the state data to the user device for presentation as part of the user interface.

15. The system of claim 1, wherein the operations further comprise receiving control command data directed to a source media entity, and forwarding the control command data to the source media entity.

16. A method, comprising:
presenting, by a user device comprising a processor a user interface that presents previews for selection of media stream content from among a first group of media streams that have been identified as being related to a first live event and a second group of media streams that have been identified as being related to a second live event;
receiving, by the user device via the user interface, first selection data indicating first selected media stream content related to the first live event, wherein the first selected media stream content was selected from the first group of media streams;
communicating, by the user device, the first selection data to a first server of the first selected media stream content;
receiving, by the user device, the first selected media stream content in response to the communicating of the first selection data;
presenting, by the user device, the first selected media stream content as first output information;
receiving, by the user device, second selection data indicating second selected media stream content related to the second live event, wherein the second selected media stream content was selected from the second group of media streams;
communicating, by the user device, the second selection data to a second server of the second selected media stream content;
receiving, by the user device, the second selected media stream content in response to the communicating the second selection data; and
presenting, by the user device, the second selected media stream content as second output information.

17. The method of claim 16, wherein at least two of the first server, the second server and a third server are a same server, wherein part of the first selected media stream content corresponds to a first source related to the first live event, and further comprising receiving, by the user device via the user interface, third selection data indicating third selected media stream content from a second source related to the first live event, communicating, by the user device, the third selection data to the third server of the third selected media stream content, receiving, by the user device, the third selected media stream content in response to the communicating the third selection data, and presenting, by the user device, the third selected media stream content as third output information.

18. A non-transitory machine-readable medium, comprising executable instructions that, when executed by a processor of a system, facilitate performance of operations, the operations comprising:
communicating, to a user device, information for presentation of a user interface for selection of media stream content from among a first group of media streams that are identified by the system as being related to a first live event and a second group of media streams that are identified by the system as being related to a second live event;
receiving, from the user device, first selection data indicating first selected media stream content from among the first group of media streams;
communicating, to the user device, the first selected media stream content in response to receiving the first selection data;
receiving, from the user device, second selection data indicating second selected media stream content from among the second group of media streams;
communicating, to the user device, the second selected media stream content in response to receiving the second selection data;
receiving, from the user device, third selection data indicating third selected media stream content from among the first group of media streams; and
communicating, to the user device, the third selected media stream content in response to receiving the third selection data.

19. (canceled)

20. The non-transitory machine-readable medium of claim 18, wherein communicating the information to the user device for presentation of the user interface comprises sending at least one of: metadata related to the first live event, or contact data related to a viewer of the first live event.

21. The system according to claim 1, wherein the selection data comprises an indication that the user device is to enabled to instruct as to changing an aspect of how the selected media stream content is to be captured, wherein the operations further comprise, based on the indication, enabling the user device to change the aspect of how the selected media stream is to be captured resulting in updated selected media stream content, and wherein the streaming of the selected media stream content is updated to be streaming the updated selected media stream content.

22. The method of claim 16, further comprising:
presenting, by the user device, selectable information during the presenting of the first selected media stream content representative of the second live event and a current status of the second live event, wherein the receiving of the first selection data is as a result of a selection of the selectable information during the presenting of the first selected media stream content.

23. The non-transitory machine-readable medium of claim 18, wherein at least one of:
the communicating of the first selected stream content comprises communicating an audio stream related to the first live event captured by an audio source and communicating a first video stream related to the first live event captured by a first video source that is distinct from the audio source, the audio stream having been captured independently of the first video stream, or
the communicating of the third selected stream content comprises communicating the audio stream captured by the audio source and communicating a second video stream related to the first live event captured by a second video source that is distinct from the first video source and the audio source, the audio stream having been captured independently of the second video stream.

24. The non-transitory machine-readable medium of claim 18, wherein communicating the information to the user device for presentation of the user interface comprises sending contact data related to a viewer of the first live event.
